(19) United States
(12) Patent Application Publication
(10) Pub. No.: US 2007/0145319 A1
(43) Pub. Date: Jun. 28, 2007

(54) Flow control device

(76) Inventor: Victor Hoernig, Lowell, IN (US)

Correspondence Address: CARLSON, GASKEY & OLDS, P.C., 400 WEST MAPLE ROAD, SUITE 350, BIRMINGHAM, MI, 48009, US

(21) Appl. No.: 11/319,320

(22) Filed: Dec. 28, 2005

(51) Int. Cl. F16K 31/44

(52) U.S. Cl. 251/248

(57) ABSTRACT

A flow control device includes a valve and a handle. The device controls the flow of water to a faucet. The handle and the faucet are located above a deck while the valve is located below the deck. An operator actuates the handle to open the valve and permits flow to the faucet. The valve is a rotating valve having a valve axis of rotation. The handle includes a rotating arm having an axis of rotation, which is substantially transverse to the valve axis of rotation.

### BACKGROUND OF THE INVENTION

This invention generally relates to a device for controlling flow through a conduit, more specifically, this invention relates to a valve trim assembly for controlling water flow to a faucet.

Devices for controlling the flow of water to a faucet are known and typically include a handle and a rotating valve. The handle communicates with the rotating valve, such that, actuating the handle opens the valve and permits flow to the faucet.

Conventional flow controlling devices are mounted adjacent a deck, such as a kitchen counter or a sink top. Ordinarily, it is desirable to position the handle in an area easily accessible to an operator. The conventional flow control device may also incorporate any number of handles to control flow to the faucet via the valve. For example, some designs include one handle for controlling the flow of hot water and a second handle for controlling the flow of cold water. Other designs include one handle for controlling the flow of both hot water and cold water. Because the handle is located above the deck in a highly visible area, the aesthetics of the handle are an important aspect of handle design.

When an operator desires a flow of water through the faucet, the operator turns the handle about the handle's axis of rotation. As the conventional handle is directly connected to the valve, actuation of the handle moves the valve from a closed position to an open position. The position of the valve and the distance between the valve and the handle varies depending on the plumbing configuration.

Conventional flow controlling devices position the axis of rotation of the handle perpendicular to the deck surface. In addition, the axis of rotation of the previous handle designs is ordinarily in-line with the axis of rotation of the valve. Because the handle experiences frequent operator interaction, the rotation path of the handle is also an important aspect of handle design and current valve configurations limit design possibilities.

Therefore, there exists a need to provide a handle and valve design wherein the axis of rotation of the handle may be angled relative to the axis of rotation of the valve. There exists a need to provide a handle and valve design wherein the axis of rotation of the handle may be parallel to the deck surface.

### SUMMARY OF THE INVENTION

A flow control device includes a valve and a handle for controlling the flow of water to a faucet. The handle and the faucet are located above a deck while the valve is located below the deck, and the handle is movable about an axis angled relative to the rotational axis of the valve.

An operator actuates the handle to open the valve and to permit flow from the water supply to the faucet. The valve rotates about a valve axis of rotation and when manipulated, moves between open and closed positions to control the flow of water through a plumbing conduit. The handle includes a rotating arm having an axis of rotation, which is substantially transverse to the valve axis of rotation. The rotating arm mounts to a post and is positioned substantially parallel to the post when the valve is open. A beveled gear translates the rotation of the rotating arm to the valve.

The flow control device mounts to the deck such that a portion of the valve is located below the deck and the handle is located above the deck. Accordingly, under normal operation, the operator may view the handle, while the deck shields the plumbing conduit from view.

These and other features of the present invention can be best understood from the following specification and drawings, the following of which is a brief description.

### BRIEF DESCRIPTION OF THE DRAWINGS

FIG. 1 illustrates example flow control devices together with a faucet and a partial sectional view of a deck.

FIG. 2 is a side view of the handle.

FIG. 3 is a plan view of the handle.

FIG. 4 is a section view taken through line 4-4 of FIG. 3.

### DETAILED DESCRIPTION OF THE PREFERRED EMBODIMENT

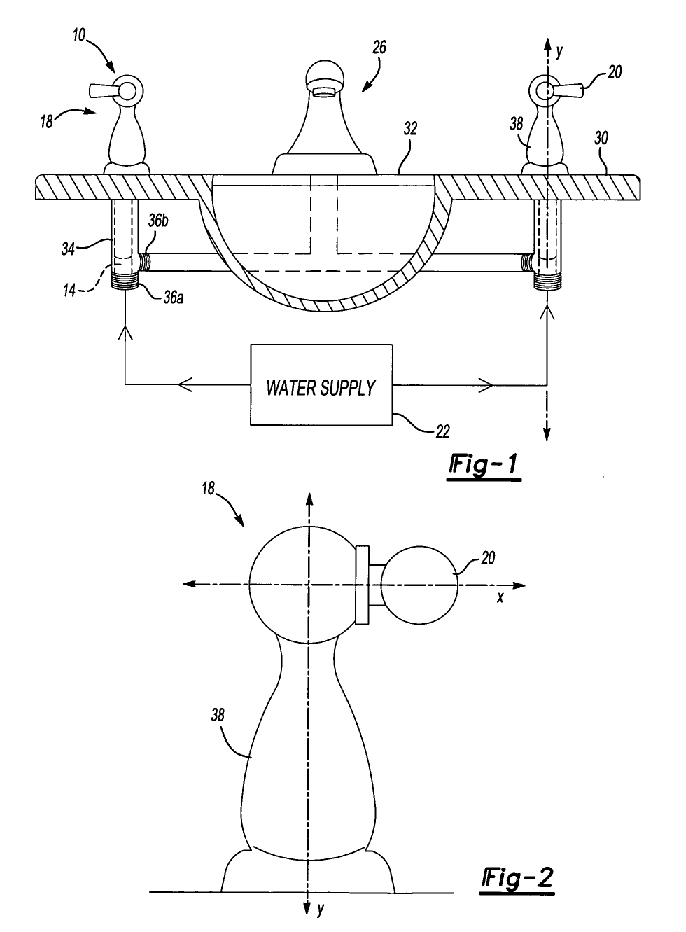

FIG. 1 illustrates a flow control device 10 including a valve 14 and a handle 18. The device 10 controls the flow of water from a water supply 22 to a faucet 26. The handle 18 and the faucet 26 are located above a deck 30 while the valve 14 is located below the deck 30.

The device 10 is typically used to control flow exiting the faucet 26 into a sink 32, such as a kitchen sink or a bathroom sink. When an operator wishes to obtain water flow from the faucet 26, the operator actuates rotating arm 20, which opens the valve 14 and permits flow to the faucet 26. The handle 18 of the device 10 mounts adjacent the deck 30, which is a countertop or other type of surface suitable for anchoring the handle 18. The handle 18 is located above the deck 30 and is positioned in an area convenient for actuation of the handle 18 by an operator. The valve 14 is primarily located below the deck 30 and hidden from view during normal operation of the valve 14.

As shown in FIG. 2, the rotating arm 20 of the handle 18 has an axis of rotation X. The rotating arms 20 in FIG. 1 and FIG. 2 are shown in a closed position, which is a position corresponding to the closed position of the valve 14. The valve 14 is partially located within a plumbing conduit 34 and, when manipulated, moves between open and closed positions thereby controlling the flow of water through the plumbing conduit 34. The valve 14 is a rotating valve having an axis of rotation Y, which is substantially transverse to the axis of rotation X of the rotating arm. Although the axis of rotation Y and the axis of rotation X are shown as having a substantially transverse relationship, many other geometries fall within the scope of the invention. Persons skilled in the art, who have the benefit of this disclosure, will be able to select other suitable angled relationships, e.g., a 45° angle, to meet their particular needs.

The plumbing conduit 34 includes male portions 36a and 36b operative to engage female conduit portions (not shown) connected to the water supply 22 and the faucet 26 respectively. The handle 18 includes a post 38 abutting the deck 30, which separates the handle 18 from the conduit 34. The flow control device 10 mounts to the deck 30 such that the valve 14 is located primarily below the deck 30 and the handle 18 is located above the deck 30. Accordingly, under normal operation, the operator may view the handle 18; the deck 30, however, shields the plumbing conduit 34 and the valve 14 from view.

The rotating arm 20 mounts to the post 38 thereby distancing the rotating arm 20 from the deck 30 and allowing the rotating arm 20 to rotate about the axis of rotation X free of interference by the deck 30. To move valve 14 from the closed position shown to an open position, the rotating arm 20 rotates approximately 90° about axis of rotation X. Other degrees of rotation are possible, for example, the rotating arm 20 may have a range of motion of 180° instead of the 90° shown. In the illustrated examples, the rotating arm 20 rotates about the axis of rotation X and is positioned substantially parallel to the post 38 when the valve 14 is in the open position.

Although the handle 18 is shown as having a single rotating arm 20, many other handle 18 designs and degrees of rotation fall within the scope of the invention. Persons skilled in the art who have the benefit of this disclosure will be able to select other suitable designs, e.g., multi-arm handles or wheel-type handles, to meet their particular needs.

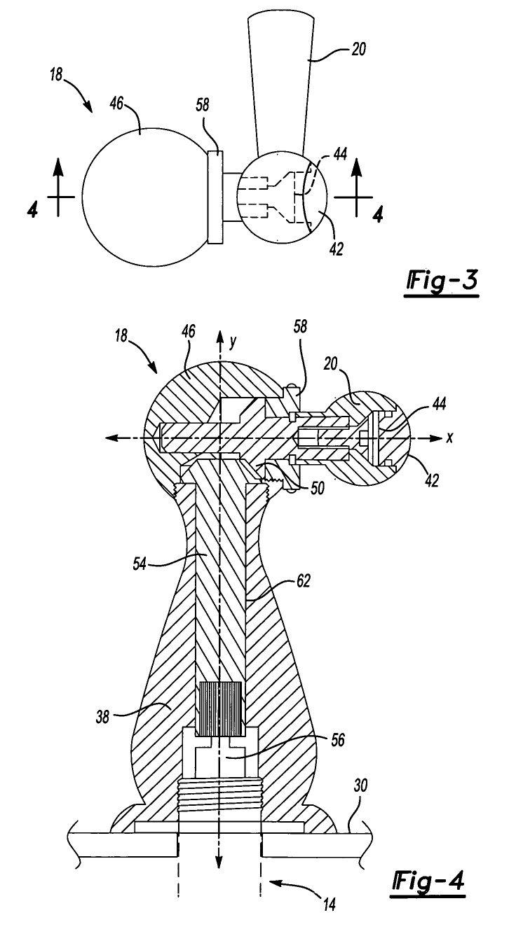

FIG. 3 depicts a plan view of the current invention. In this view, the rotating arm 20 is shown in the closed position. Screw cap 42 covers a screw 44, which secures the rotating arm 20 to a beveled gear 50 within a head 46. The screw cap 42 is a decorative cover and hides the screw 44 from view during normal handle 18 operation.

The sectional view of FIG. 4 is taken through line Z of FIG. 3 and further illustrates the relationship of the rotating arm 20 to the valve 14. The beveled gear 50 translates the movements of the rotating arm 20 through a spindle extension 54 and to the valve 14. The beveled gear 50 includes a first end having a threaded aperture for receiving the screw 44, which secures the rotating arm 20 to the beveled gear 50. A second end of the beveled gear 50 is disposed in an aperture within the head 46. A gear retainer ring 58 secures the beveled gear 50 to the head 46 and permits rotation of the handle 18 relative to the head 46. Securing the beveled gear 50 in this manner enables the beveled gear 50 to rotate about the axis of rotation X.

The spindle extension 54 includes a first end having a portion meshing with the beveled gear 50. A second end of the spindle extension 54 extends proximate the deck 30 and engages a valve stem 56. The second end includes a keyed aperture that rotatably engages the valve stem 56, such that a rotation of the spindle extension 54 rotates the valve stem 56, which moves the valve 14 of the device between open positions and closed positions.

The spindle extension 54 is partially disposed within a shaft 62 in the post 38. The shaft 62 allows the spindle extension to rotate about axis of rotation Y when the rotating arm 20 actuates the beveled gear 50. A first end of shaft 62 secures the head 46. The second end of shaft 62 abuts the surface of the deck 30, such that, when assembled, the spindle extension 54 and the beveled gear 50 are hidden from view.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A plumbing device for controlling flow, comprising:
a rotating valve moveable between an open position and a closed position; and
a handle operative to move said rotating valve, wherein said handle is rotatable about a handle axis transverse to movement of said rotating valve.

2. The plumbing device of claim 1, wherein said handle axis is transverse to a direction of flow through said rotating valve.

3. The plumbing device of claim 1, wherein said handle axis is transverse to a direction of flow at the inlet of said rotating valve.

4. The plumbing device of claim 1, wherein said handle axis is substantially parallel to a deck surface.

5. The plumbing device of claim 1, wherein said rotating valve rotates about a valve axis perpendicular to said handle axis.

6. The plumbing device of claim 1, including a gear system translating movement of said handle to said valve.

7. The plumbing device of claim 6, wherein said gear system includes a beveled gear.

8. The plumbing device of claim 7, including a post supporting said handle, said post having a first end adjacent said deck surface and a second end including said handle.

9. The plumbing device of claim 8, wherein said second end includes a beveled gear disposed within a head.

10. The plumbing device of claim 9, wherein said beveled gear translates movement of said handle about said handle axis of rotation to movement about an axis of rotation of said valve.

11. A decorative plumbing device for controlling flow, comprising:
a rotatable valve disposed in a conduit and operative to control flow through a portion of said conduit, a portion of said valve located below a deck surface; and
a rotatable handle operative to actuate said valve, said handle located above said deck surface, wherein said handle is rotatable about a handle axis different from an axis of rotation of said valve.

12. The decorative plumbing device of claim 11, wherein said handle axis is substantially parallel with said deck surface.

13. The decorative plumbing device of claim 11, wherein said handle mounts to a post extending from said deck surface.

14. The decorative plumbing device of claim 13, including a spindle extension disposed in said post translating movement of said handle to said valve.

15. The decorative plumbing device of claim 14, wherein said spindle extension includes a first end engaged to a beveled gear.

16. The decorative plumbing device of claim 15, wherein said spindle extension includes a second end engaged to a valve.

17. A device for controlling a valve assembly, comprising:
a post mountable to a mounting deck, said post including an inner cavity;
an elongated member rotatable within said cavity of said post, wherein said member is rotatable about a first axis and a handle portion of the device is rotatable about a second axis transverse to said first axis.

18. The device of claim 17, wherein said first axis is substantially parallel to a deck surface.

19. The device of claim 17, wherein said second axis is transverse to a deck surface.
